(19) United States
(12) Patent Application Publication
(10) Pub. No.: US 2007/0217071 A1
(43) Pub. Date: Sep. 20, 2007

(54) Magnetic recording medium, method of manufacturing the same, and magnetic recording apparatus

(75) Inventors: Ryosaku Inamura, Kawasaki (JP); Isatake Kaitsu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/476,002

(22) Filed: Jun. 28, 2006

(30) Foreign Application Priority Data
Mar. 16, 2006 (JP) 2006-072924

(51) Int. Cl. G11B 5/82

(52) U.S. Cl. 360/135

(57) ABSTRACT

According to the present invention, provided is a magnetic recording medium 11 comprising: a non-magnetism base member 1; a lower soft magnetic underlying layer 2 formed on the non-magnetism base member 1; a non-magnetic layer 4 formed on the lower soft magnetic underlying layer 2; an upper soft magnetic underlying layer 6 formed on the non-magnetic layer 4; and a recording layer 9 having a perpendicular magnetic anisotropy, the recording layer 9 being formed on the upper soft magnetic underlying layer 6, wherein crystalline magnetic layers 3 and 5 are formed between the lower soft magnetic underlying layer 2 and the non-magnetic layer 4 or between this non-magnetic layer 4 and the upper soft magnetic underlying layer 6.

### CROSS-REFERENCE TO RELATED APPLICATIONS

This application is based on and claims priority of Japanese Patent Application No. 2006-072924 filed on Mar. 16, 2006, the entire contents of which are incorporated herein by reference.

### BACKGROUND OF THE INVENTION

1. Field of the Invention

The present invention relates to a magnetic recording medium, a method of manufacturing magnetic recording medium, and a magnetic recording apparatus.

2. Description of the Related Art

In recent years, in magnetic storage apparatuses such as a hard disk drive unit, increase in the storage capacity has been remarkable, and the surface recording density of the magnetic recording medium incorporated in the apparatus has been steadily increasing. Those used as such a magnetic recording medium for many years include an in-plane recording medium, in which the direction of magnetization recorded in a recording layer is in the in-plane direction. However, in the in-plane magnetic recording medium, recording bits are prone to disappear due to a recording magnetic field and a thermal fluctuation, and therefore densification of the surface recording density is coming to the limitation.

Then, as a medium in which recording bits are thermally more stable than the in-plane magnetic recording medium and densification is possible, a perpendicular magnetic recording medium, in which the direction of magnetization recorded in a recording layer is in a direction perpendicular to the medium, has been developed and is now put in practical use for some products.

Among the perpendicular magnetic recording media, the one in which a soft-magnetic underlying layer is formed under a perpendicular magnetic recording layer has such a feature that the soft-magnetic underlying layer serves as a part of a magnetic recording head, so that a recording magnetic field coming out of the magnetic recording head enters the soft magnetic underlying layer almost perpendicularly. For this reason, with a combination of this type of perpendicular recording medium and a magnetic recording head, a recording magnetic field, in which the flux density is large and furthermore the gradient of the magnetic field is steep, can be led into a perpendicular magnetic recording layer almost perpendicularly, making it possible to achieve more densification of the surface recording density.

In the perpendicular magnetic recording media provided with the soft magnetic underlying layer, a large noise other than a writing signal is observed in some situations. This noise is called a spike noise, which is caused by a magnetic leakage flux coming from a magnetic wall of the soft magnetic underlying layer. In order to achieve a certain bit error rate in the magnetic recording medium, it is important how to suppress this spike noise.

The above-described magnetic wall of the soft magnetic underlying layer arises because different magnetic domains mutually direct in different directions in the layer.

In view of this, in Non-patent Documents 1 and 2, an anti-ferromagnetic layer or a ferromagnetic layer is formed adjacent to the soft magnetic underlying layer in order to align the directions of magnetization in the soft magnetic underlying layer in the same direction at all portions in the layer and to reduce the spike noise.

However, in this approach, a polarization process, such as heat treatment in magnetic field, for aligning the magnetization direction of the soft magnetic underlying layer is needed, and the production cost of the magnetic recording medium increases by this process, and additionally the material cost of anti-ferromagnetic material is high. Therefore, this approach is not suitable for mass production.

On the other hand, in Patent Document 1 and Non-patent Documents 3 and 4, a soft magnetic underlying layer is divided into two layers consisting of an upper and a lower by forming an extremely thin non-magnetic layer at a height in the middle of the soft magnetic underlying layer, so that the respective magnetizations of the respective divided underlying layers direct in opposite directions by utilizing Ruderman-Kittel-Kasuya-Yosida (RKKY) exchange interaction.

This allows a magnetic flux coming out of a magnetic domain of the lower underlying layer to pass through a magnetic domain of the upper underlying layer and return to the lower underlying layer again, so that the magnetic flux circulates inside the underlying layer, and therefore, the magnetic leakage flux which is a cause of the spike noise is reduced. Moreover, in this approach, because the polarization process like the one in Non-patent Documents 1 and 2 is not needed, the spike noise can be reduced while the production cost is suppressed.

[Patent Document 1] Japanese laid-open Official Gazette No. 2001-155321

[Non-patent Document 1] Takenori, S. et al., “Exchange-coupled IrMn/CoZrNb soft underlayers for perpendicular recording media”, IEEE Transactions on Magnetics, September 2002, Vol. 38, Pages 1991-1993

[Non-patent Document 2] Ando, T. et al., “Triple-layer perpendicular recording media for high SN ratio and signal stability”, IEEE Transactions on Magnetics, September 1997, Vol. 33, Pages 2983-2985

[Non-patent Document 3] Byeon, S. C. et al., “Synthetic anti-ferromagnetic soft underlayers for perpendicular recording media”, IEEE Transactions on Magnetics, July 2004, Vol. 40, Pages 2386-2388

[Non-patent Document 4] Acharya, B. R. et al., “Anti-parallel coupled soft underlayers for high-density perpendicular recording”, IEEE Transactions on Magnetics, July 2004, Vol. 40, Pages 2383-2385

### SUMMARY OF THE INVENTION

According to one aspect of the present invention, there is provided a magnetic recording medium comprising: a base member; a lower soft magnetic underlying layer formed on the base member; a non-magnetic layer formed on the lower soft magnetic underlying layer; an upper soft magnetic underlying layer formed on the non-magnetic layer; and a recording layer formed on the upper soft magnetic underlying layer and having a perpendicular magnetic anisotropy, wherein a crystalline magnetic layer is formed between the lower soft magnetic underlying layer and the non-magnetic layer or between the non-magnetic layer and the upper soft magnetic underlying layer.

According to the present invention, the crystalline magnetic layer whose interface with the non-magnetic layer is stabile is formed, thereby suppressing the diffusion of the constituent material of the non-magnetic layer into the lower soft magnetic underlying layer or into the upper soft magnetic underlying layer due to an aged deterioration or the like. Accordingly, the lower soft magnetic underlying layer and the upper soft magnetic underlying layer are distinctly separated by the non-magnetic layer, so that these soft magnetic underlying layers anti-ferromagnetically couple to each other excellently. Consequently, a magnetic leakage flux which leaks from each underlying layer to the outside of the magnetic recording medium can be reduced, so that the spike noise due to the magnetic leakage flux can be suppressed effectively.

In particular, since an amorphous material and a microcrystalline material does not have a distinct magnetic domain structure, the magnetic wall is difficult to occur in these materials. Therefore, the amorphous material and the microcrystalline material is suitable for the constituent materials for the lower soft magnetic underlying layer and the upper soft magnetic underlying layer.

It should be noted, however, that other elements can easily diffuse into the film made of the amorphous or the microcrystalline material, since the structure of these materials is in a quasi-stable state. Despite using the amorphous or the microcrystalline material as the soft magnetic underlying layer, constituent material of the non-magnetic layer is prevented from diffusing into the soft magnetic underlying layer by the crystalline magnetic layer in the present invention. Therefore, even when the amorphous or the microcrystalline material is employed as the soft magnetic layer, increase of the spike noise due to the diffusion of the materials can be suppressed, while suppressing the generation of the magnetic wall by the nature of the amorphous or the microcrystalline material in the present invention.

According to another aspect of the present invention, there is provided a method of manufacturing a magnetic recording medium comprising the steps of: forming a lower soft magnetic underlying layer on a base member; forming a non-magnetic layer on the lower soft magnetic underlying layer; forming an upper soft magnetic underlying layer on the non-magnetic layer; forming a recording layer on the upper soft magnetic underlying layer, the recording layer having a perpendicular magnetic anisotropy; and forming a protective layer on the recording layer while heating the base member, wherein the method includes a step of forming a crystalline magnetic layer on the lower soft magnetic underlying layer before the step of forming the non-magnetic layer, or the step of forming the crystalline magnetic layer on the non-magnetic layer before the step of forming the upper soft magnetic underlying layer.

In the present invention, by heating the base member in the step of forming the protective layer, the protective layer is densified to improve its mechanical strength and an HDI (Head Disk Interface) characteristic. Because the diffusion of the constituent material of the non-magnetic layer into the soft magnetic underlying layers is prevented by the crystalline magnetic layer even if the base member is heated this manner, simultaneous pursuit of improvement in the film quality of the protective layer and the suppression of the magnetic leakage flux can be achieved.

According to a further aspect of the present invention, there is provided a magnetic recording apparatus comprising: a magnetic recording medium comprising: a base member; a lower soft magnetic underlying layer formed on the base member; a non-magnetic layer formed on the lower soft magnetic underlying layer; an upper soft magnetic underlying layer formed on the non-magnetic layer; and a recording layer formed on the upper soft magnetic underlying layer and having a perpendicular magnetic anisotropy; and a magnetic head provided so as to face the magnetic recording medium, wherein a crystalline magnetic layer is formed between the lower soft magnetic underlying layer and the non-magnetic layer or between the non-magnetic layer and the upper soft magnetic underlying layer.

### BRIEF DESCRIPTION OF THE DRAWINGS

FIGS. 1A to 1C are cross sectional views in the course of manufacturing a magnetic recording medium according to a first embodiment of the present invention.

FIG. 2 is a cross sectional view for explaining an operation of writing to the magnetic recording medium according to the first embodiment of the present invention.

FIG. 3 is a cross sectional view of a sample for investigating advantages obtained from the magnetic recording medium according to the first embodiment of the present invention.

FIG. 4 is a cross sectional view of a sample concerning a comparative example.

FIG. 5 is a cross sectional view of a sample concerning another comparative example.

FIG. 6 is a graph obtained after carrying out an X-ray diffraction measurement to the first embodiment of the present invention and to the comparative example, respectively.

FIG. 7 is a graph obtained after investigating how an exchange coupling magnetic field in a soft magnetic underlying layer varies with substrate temperature in the first embodiment of the present invention and in the comparative example, respectively.

FIG. 8 is a graph obtained after investigating a relationship between the film thickness of a crystalline magnetic layer and an exchange coupling magnetic field in the soft magnetic underlying layer, in the first embodiment of the present invention.

FIG. 9 is a graph obtained after investigating a relationship between the film thickness of the crystalline magnetic layer and an S/N ratio, in the first embodiment of the present invention.

FIG. 10 is a graph obtained after investigating a relationship between the film thickness of the crystalline magnetic layer and a coercivity of a recording layer, in the first embodiment of the present invention.

FIG. 11 is a plane view of a magnetic recording apparatus according to a second embodiment of the present invention.

### DESCRIPTION OF THE PREFERRED EMBODIMENTS

Hereinafter, a detailed description of the preferred embodiments of the present invention will be provided by referring to the accompanying drawings.

### (1) First Embodiment

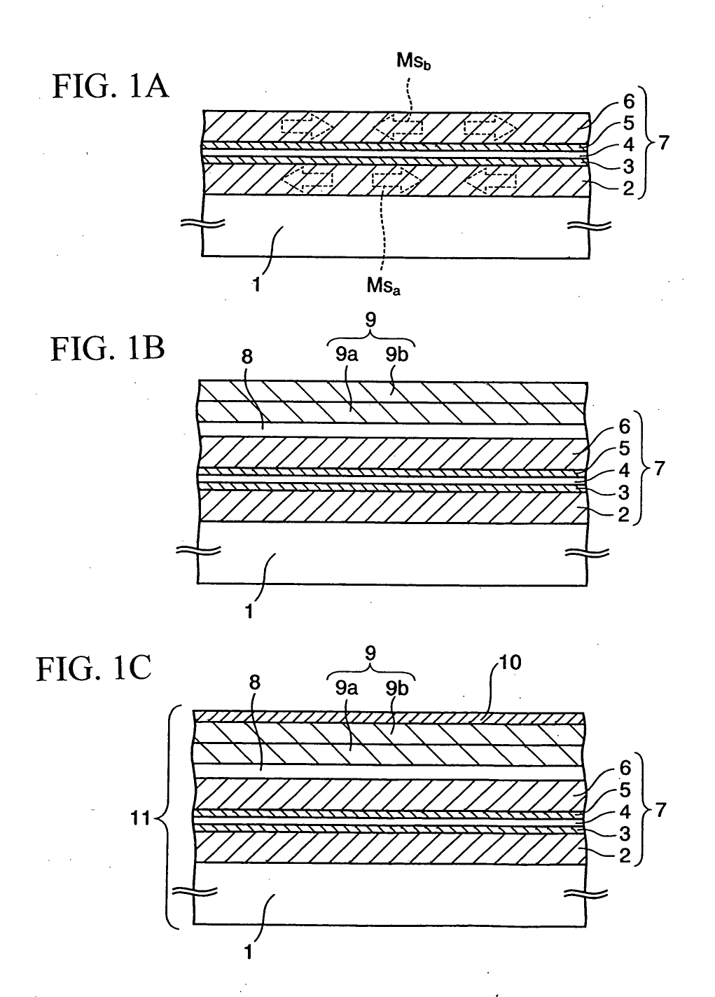

FIGS. 1A to 1C are cross sectional views in the course of manufacturing a magnetic recording medium according to the present embodiment.

First, the steps until obtaining the sectional structure shown in FIG. 1A are described.

First, CoNbZr layer is formed as a lower soft magnetic underlying layer 2 to a thickness of about 20 to 24 nm on a non-magnetic base member 1 that is manufactured by applying an NiP plating to the surface of an Al alloy base member or a chemically strengthened glass base member. CoNbZr layer for the lower soft magnetic underlying layer 2 is an amorphous material, and is formed by a DC sputtering method with an input electric power of 1 kW in an Ar atmosphere of the pressure of 0.5 Pa.

Note that, a crystallized glass, or a silicon substrate in which a thermal oxidation layer is formed on the surface thereof may be used as the non-magnetic base member 1. Furthermore, the lower soft magnetic underlying layer 2 is not limited to the CoNbZr layer. An alloy layer in an amorphous region or in a microcrystalline structure region, formed by adding at least any one of Zr, Ta, C, Nb, Si and B to any one of a Co group, an Fe group and an Ni group, may be formed as the lower soft magnetic underlying layer 2. Such material includes, for example, CoNbTa, FeCoB, NiFeSiB, FeAlSi, FeTaC, FeHfC and the like.

Moreover, although a DC sputtering method is used as the deposition method hereinafter unless otherwise noted, the method of depositing film is not limited to the DC sputtering method. An RF sputtering method, a pulse DC sputtering method, a CVD (Chemical Vapor Deposition) method, or the like can also be employed as the deposition method.

Next, an NiFe layer is formed on the lower soft magnetic underlying layer 2 as a lower crystalline magnetic layer 3 to a thickness of 1 to 5 nm by the DC sputtering method with an input electric power of 200 W in an Ar atmosphere of the 0.5 Pa pressure. The lower crystalline magnetic layer 3 is not limited to the NiFe layer. A layer composed only of any one of Ni, Fe and Co, or a layer composed of an alloy containing at least any one of these elements, may be formed as the lower crystalline magnetic layer 3.

Moreover, a lower limit of the thickness of the lower crystalline magnetic layer 3 is set to a minimum thickness required for the crystalline magnetic layer 3 to be a continuous film. If the thickness is 1 to 3 nm or more, which varies depending on the material, the crystalline magnetic layer 3 becomes the continuous film.

Moreover, if the thickness of the layer 3 is too thick, characteristic of the crystalline magnetic layer 3 is reflected more strongly than that of the lower soft magnetic underlying layer 2 in the media, which in turn forms a magnetic wall serving as a source of the spike noise in the crystalline magnetic layer 3. Therefore, it is preferable that the crystalline magnetic layer 3 be formed as thin as possible, for example, in the thickness of 10 nm or less.

Next, an Ru layer is formed to the thickness of approximately 0.7 nm as a non-magnetic layer 4 on this crystalline magnetic layer 3 by the DC sputtering method. Although the deposition condition at this time is not limited, a condition in which an input electric power is set to 150 W in an Ar atmosphere of 0.5 Pa pressure is employed in this embodiment.

Furthermore, the non-magnetic layer 4 is not limited to the Ru layer. The non-magnetic layer 4 may be composed only of any one of Ru, Rh, Ir, Cu, Cr, Re, Mo, Nb, W, Ta and C, or composed of an alloy containing at least any one of these elements, or composed of Mgo.

Then, an NiFe layer is formed as an upper crystalline magnetic layer 5 on the non-magnetic layer 4 to the thickness of approximately 1 to 5 nm by the DC sputtering method. As the deposition condition for the NiFe layer, the input electric power of 150 W and the pressure of Ar atmosphere of 0.5 Pa and employed, for example.

Next, CoNbZr, which is an amorphous material, is deposited on the upper crystal magnetic layer 5 as an upper soft magnetic underlying layer 6 to the thickness of approximately 20 to 24 nm. The upper soft magnetic underlying layer 6 is not limited to the CoNbZr layer. Like the lower soft magnetic underlying layer 2, an alloy layer in an amorphous region or in a microcrystalline structure region, formed by adding at least any one of Zr, Ta, C, Nb, Si and B to any one of a Co group, an Fe group and an Ni group, may be formed as the upper soft magnetic underlying layer 6.

Through the steps so far, an underlying layer 7 composed of the respective layers 2 to 6 has been formed on the non-magnetic base member 1.

In this underlying layer 7, the lower soft magnetic underlying layer 2 and the upper soft magnetic underlying layer 6 are isolated from each other by the non-magnetic layer 4. Accordingly, a direction of a magnetization MSₐ which is obtained by combining the lower soft magnetic underlying layer 2 and the lower crystalline magnetic layer 3, and a magnetization MS_{b} which is obtained combining the upper soft magnetic underlying layer 6 and the upper crystalline magnetic layer 5 are stabilized in an antiparallel condition, i.e., in a state where the respective soft-magnetic layers 2 and 6 are anti-ferromagnetically coupled to each other. Such a state appears periodically as the thickness of the non-magnetic layer 4 increases, and it is preferable to form the non-magnetic layer 4 to the thinnest thickness under which the above state appears. Such thickness is about 0.7 to 1 nm, when the Ru layer is formed as the non-magnetic layer 4.

By making the magnetizations Msₐ and MS_{b} into antiparallel in this manner, the magnetic flux in the underlying layer 7 circulates in the layer 7 and thus is difficult to leak out, so that the spike noise resulting from a magnetic leakage flux can be reduced.

Moreover, a magnetic fluxes f₁ and f₂ may be set equal, where f₁ is the magnetic flux passing through the lower soft magnetic underlying layer 2 and lower crystalline magnetic layer 3, and f₂ is a magnetic flux passing through the upper soft magnetic underlying layer 6 and upper crystalline magnetic layer 5. By setting magnetic fluxes f₁ and f₂ equal in this manner, it is made possible to surely circulate the magnetic fluxes within the under layer 7.

Equality of f₁ and f₂ can be achieved by making t₂·Ms₂+t₃·Ms₃ and t₅·Ms₅+t₆·Ms₆ equal, where the t₂·Ms₂+t₃·Ms₃ is a sum of the respective film thickness and magnetization of the lower soft magnetic underlying layer 2 and the lower crystalline magnetic layer 3, and t₅·Ms₅+t₆·Ms₆ is a sum of the respective film thickness and magnetization of the upper crystalline magnetic layer 5 and the upper soft magnetic underlying layer 6.

Furthermore, in the case where a saturation magnetic flux density Bs of the underlying layer 7 is 1T or more, a total thickness of the underlying layer 7 is set preferably to 10 nm or more, more preferably to 30 nm or more, from the viewpoint of the easiness of writing and reproducing by a magnetic head. However, because the manufacturing cost increases if the total film thickness of the underlying layer 7 is too thick, the total film thickness of the layer 7 is set preferably to 100 nm or less, more preferably to 60 nm or less.

Next, as shown in FIG. 1B, a Ru layer is formed on the underlying layer 7 to the thickness of about 20 nm by a DC sputtering method with an input electric power of 250 W in an Ar atmosphere of 8 Pa pressure, and this Ru layer is used as a non-magnetic underlayer 8.

It should be noted that the non-magnetic underlayer 8 is not limited to such single-layered structure. The non-magnetic underlayer 8 may be formed of layers consisting of two or more layers. In this case, it is preferable to form a layer composed of a Ru alloy with any one of Co, Cr, Fe, Ni and Mn for the layer constituting the non-magnetic underlayer 8.

Furthermore, the non-magnetic underlayer 8 may be formed after an amorphous seed layer is formed on the underlying layer 7 in order to improve the crystal orientation of the non-magnetic underlayer 8 and controlling the crystal grain diameter of the layer 8. In this case, it is preferable to form the seed layer composed any one of Ta, Ti, C, Mo, W, Re, Os, Hf, Mg and Pt, or of an alloy layer of these elements.

Then, CoCrPt—Si0₂ of a granular structure is deposited on the non-magnetic underlayer 8 to the thickness of about 10 nm by a DC sputtering method with an input electric power of 350 W in an Ar atmosphere of about 3 Pa pressure, and this CoCrPt—Si0₂ layer is used a main recording layer 9a.

Then, a CoCrPtB layer is formed as a writing-assist layer 9b on the main recording layer 9a to the thickness of about 6 nm by a sputtering method with an input electric power of 400 W in an Ar atmosphere of 0.5 Pa pressure.

According to these steps, a recording layer 9 having a perpendicular magnetic anisotropy, constructed from the main recording layer 9a and the writing-assist layer 9b, is formed on the non-magnetic underlayer 8.

The respective anisotropic magnetic fields Hₖ₁ and Hₖ₂ as well as magnetization reversal parameters a₁ and a₂ of the main recording layer 9a and writing-assist layer 9b formed under the above conditions satisfy Hₖ₁>Hₖ₂ and a₁<a₂, respectively. Such characteristic is observed when the perpendicular magnetic anisotropy of the main recording layer 9a is larger than that of the writing-assist layer 9b. Therefore, a structure, in which the main recording layer 9a having a large perpendicular magnetic anisotropy and the writing-assist layer 9b having a small perpendicular magnetic anisotropy are laminated, is formed in the present embodiment.

Because the main recording layer 9a has such a large perpendicular magnetic anisotropy, with the main recording layer 9a alone the magnetization is difficult to be reversed by an external magnetic field and it is difficult to write magnetic information. However, when the writing-assist layer 9b, in which the perpendicular magnetic anisotropy is weak and hence the magnetization is easily reversed by an external magnetic field, is provided in contact with the main recording layer 9a, the magnetization of the main recording layer 9a is reversed along with the reversal of magnetization of the writing-assist layer 9b by the interaction between spins of these layers 9a and 9b. Thus, it is easy to write magnetic information into the main recording layer 9a.

Moreover, because the perpendicular magnetic anisotropy of the main recording layer 9a is large, directions of the magnetizations in each magnetic domain of the main recording layer 9a is stabilized due to the interaction between these magnetizations. Therefore, the direction of the magnetization which bears magnetic information is difficult to be reversed by heat, and thus the thermal-fluctuation resistance of the main recording layer 9a is increased.

Such double-layered structure is preferable for the recording layer 9 under the situation where the simultaneous pursuit of the thermal-fluctuation resistance and easiness of writing is required. However, if this is not required, the recording layer 9 may have single-layered structure. Furthermore, the recording layer 9 may have multi-layered structure with three or more layers.

Then, as shown in FIG. 1C, by an RF-CVD (Radio Frequency Chemical Vapor Deposition) method using a C₂H₂ gas as the reactant gas, a DLC (Diamond Like Carbon) layer is formed as a protective layer 10 on the recording layer 9 to the thickness of about 4 nm. The deposition conditions of the protective layer 10 are: a deposition pressure of about 4 Pa, a high frequency electric power of 1000 W, a bias voltage of 200V between the substrate and a shower head, and the substrate temperature of 200° C., for example.

Next, after applying lubricant (not shown) to the thickness of about 1 nm onto the protective layer 10, surface protrusions and foreign substances on the protective layer 10 are removed using a polishing tape.

In this way, the basic structure of a magnetic recording medium 11 according to this embodiment is completed.

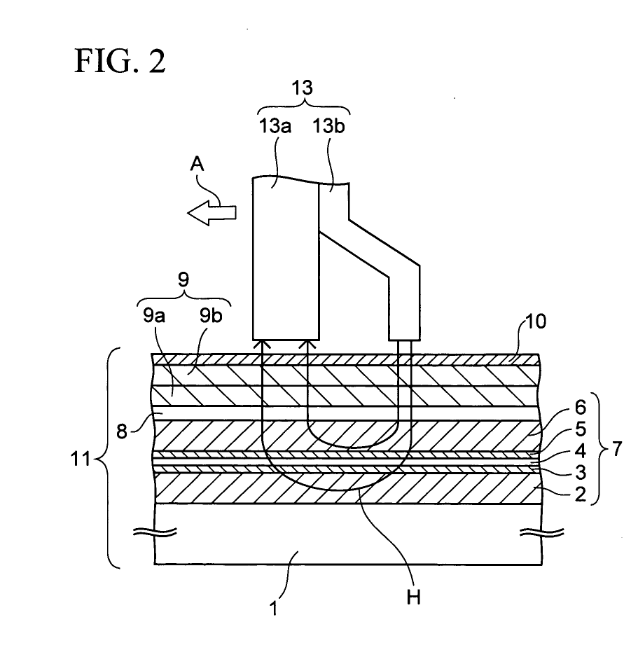

FIG. 2 is a cross sectional view for explaining an operation of writing to this magnetic recording medium 11.

In order to write to the medium 11, as shown in FIG. 2, a magnetic head 13 comprising a main pole 13b and a return yoke 13a is caused to face the magnetic recording medium 11. Then, a recording magnetic field H, which is generated at the main pole 13b of a small cross section and thus has a high flux density, is passed into the recording layer 9. According to this, in a magnetic domain, which exists directly under the main pole 13b, of the main recording layer 9a having a perpendicular magnetic anisotropy, the magnetization is reversed by this recording magnetic field H and thus information is written.

After passing through the main recording layer 9a perpendicularly this way, the recording magnetic field H runs in the in-plane direction of the underlying layer 7, which forms a magnetic flux circuit together with the magnetic head 13, and the recording magnetic field H passes through the main recording layer 9a again and is then fed back with a low flux density to the return yoke 13a of a large cross section. The underlying layer 7 plays the role to lead the recording magnetic field H into the film in this way and to cause the recording magnetic field H to pass through the recording layer 9 perpendicularly.

Then, by changing the direction of the recording magnetic field H in response to recording signals while relatively moving the magnetic recording medium 11 and the magnetic head 13 in the A-direction of FIG. 2, a plurality of magnetic domains which are perpendicularly magnetized are formed in a truck direction of the recording medium 11, and thus the recording signals are recorded in the magnetic recording medium 11.

As described in FIG. 1C, the lower crystalline magnetic layer 3 and the upper crystalline magnetic layer 5 are formed above and below the non-magnetic layer 4 respectively in this embodiment. Hereinafter, advantages obtained by such a structure are described.

In the steps of forming the magnetic recording medium 11, there is a step of heating the base member 1 like the step of forming the protective layer 10 of FIG. 1C. The DLC layer which constitutes the protective layer 10 needs to have a diamond structure, which is mechanically strong and excellent in the HDI characteristic, in order that the DLC layer is not damaged even if the DLC layer touches the magnetic head. For this reason, in the step of forming the protective layer 10 using a CVD method, heating the base member 1 is inevitable in order to deposit carbon microparticles with a diamond structure on the base member.

However, if a heat is applied to the base member 1 in the case where the crystalline magnetic layers 3 and 5 are not formed, Ru atoms and the like constituting the non-magnetic layer 4 diffuse into each of the soft magnetic underlying layers 2 and 6 which are in a quasi-stable state of an amorphous material or a microcrystalline material. Therefore, underlying layers 2 and 6 are difficult to anti-ferromagnetically couple to each other, so that a spike noise is prone to occur.

Moreover, even if the heat is not applied in the process, the above-described diffusion may occur due to the aged deterioration, so that the spike noise may increase as the used hours of the recording medium 11 increases.

Since an amorphous material and a microcrystalline material do not have a distinct magnetic domain structure, magnetic walls are difficult to appear in these materials, and hence these materials are suitable for the constituent material of the underlying layers 2 and 6. Therefore, it is desirable to prevent the constituent atoms of the non-magnetic layer 4 from diffusing into the underlying layers 2 and 6, while the underlying layers 2 and 6 are composed of an amorphous material or a microcrystalline material.

In view of this, in this embodiment, the lower crystalline magnetic layer 3 and the upper crystalline magnetic layer 5 are formed above and below the non-magnetic layer 4 respectively, as described above. Because the crystalline magnetic layers 3 and 5 have a stable crystal structure, the interfaces with the non-magnetic layer 4 are stabilized and the constituent atoms of the non-magnetic layer 4 are difficult to diffuse into each of the crystalline magnetic layers 3 and 5. Accordingly, even if the base member 1 is heated during the process or the operating time of the magnetic recording medium 11 extends for a long period of time, the lower soft magnetic underlying layer 2 and the upper soft magnetic underlying layer 6 easily couple to each other anti-ferromagnetically. Thus, it is possible to surely reduce the spike noise.

Next, the results of an investigation which was conducted by the present inventors in order to confirm the above-described advantages are described.

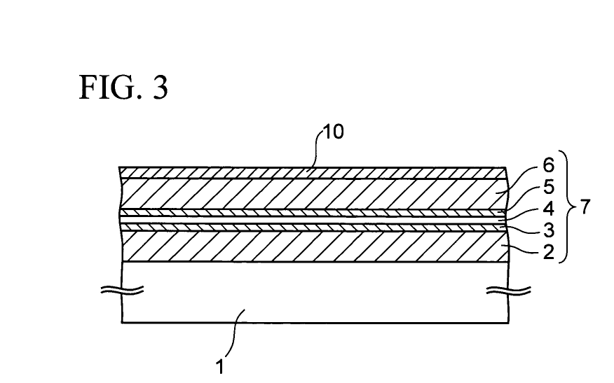

FIG. 3 is a cross sectional view of Samples A to D used in this investigation. It should be noted that for the elements described in FIGS. 1A to 1C, the same numerals as those in these drawings are used in FIG. 3. The configurations of respective samples A to D are as follows.

Sample A

In Sample A, the same materials and the same film thicknesses as those described in FIGS. 1A to 1C were employed to form the respective layers 2 to 6. Moreover, in order to investigate the dependency on heating temperature before forming the protective layer 10, the protective layer 10 was formed after heating the base member 1 in a range of a room temperature to 250° C.

Sample B

In Sample B, the thickness of the Ru non-magnetic layer 4 was set to 0.6 nm, which was thinner than Sample A, to thereby weaken an exchange coupling magnetic field Hₑₓ of the soft magnetic underlying layers 2 and 6.

Sample C

In Sample C, a Co layer with a thickness of 1 to 5 nm was formed as the crystalline magnetic layers 3 and 5. Other structures were the same as Sample A.

Sample D

In Sample D, an Fe layer with a thickness of 1 to 5 nm was formed as the crystalline magnetic layers 3 and 5. Other structures were the same as Sample A.

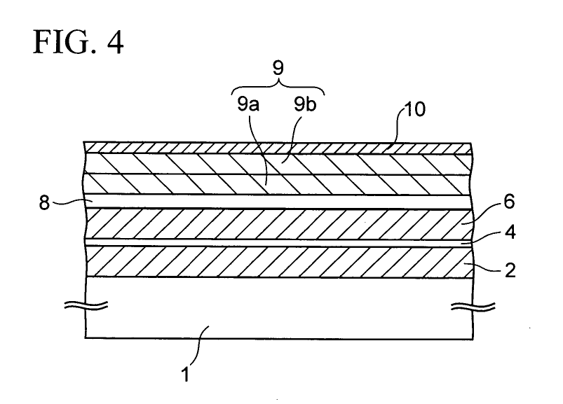

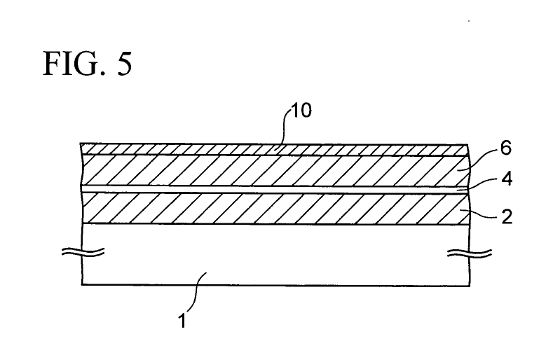

Moreover, in order to confirm the effectiveness of this embodiment, Comparative Examples A to C to be described hereinafter were also prepared. FIGS. 4 and 5 are cross sectional views of these samples. In FIGS. 4 and 5, for the same elements as those of FIGS. 1A to 1C the same numerals are given and the description thereof is omitted. The configurations of the respective Comparative Examples A to C are as follows.

### COMPARATIVE EXAMPLE A

FIG. 4 is a cross sectional view of Comparative Example A. In Comparative Example A, the crystalline magnetic layers 3 and 5 were not formed. Moreover, in order to equalize the magnitudes of the respective anisotropic magnetic fields of the CoNbZr soft magnetic underlying layers 2 and 6, both these layers were formed in the thickness of 25 nm.

### COMPARATIVE EXAMPLE B

FIG. 5 is a cross sectional view of Comparative Example B. Like in Comparative Example A, the crystalline magnetic layers 3 and 5 were not formed in Comparative Example B. The thicknesses of the CoNbZr soft magnetic underlying layers 2 and 6 both were set to 25 nm in order to equalize the magnitudes of their anisotropic magnetic fields. Moreover, in order to investigate the dependency on heating temperature before forming the protective layer 10, the protective layer 10 was formed after heating the base member 1 in a range of room temperature to 250° C.

### COMPARATIVE EXAMPLE C

In Comparative Example C, the exchange coupling magnetic field Hₑₓ of the CoNbZr soft magnetic underlying layers 2 and 6 was weakened by thinning the thickness of the Ru non-magnetic layer 4 down to 0.6 nm in the same layer structure as that of Comparative Example B.

Hereinafter, the effect of the present embodiment will be verified.

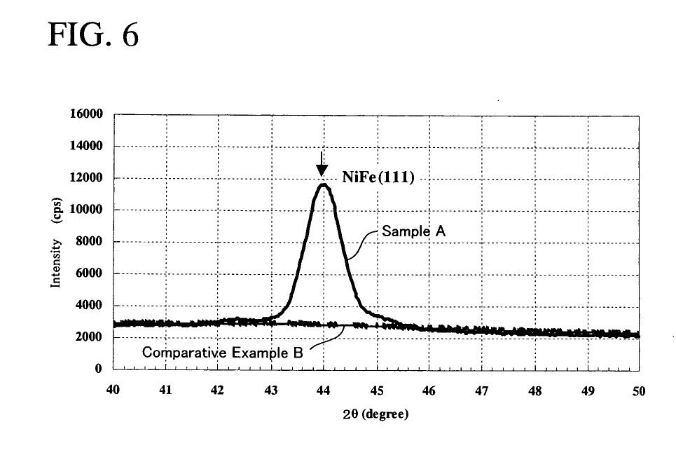

FIG. 6 is a graph obtained after carrying out an X-ray diffraction measurement to each of Sample A and Comparative Example B, where the horizontal axis of the graph represents a twice the diffraction angle θ and the perpendicular axis of the graph represents the intensity of X-ray.

As shown in FIG. 6, in Sample A, an NiFe (111) diffraction peak was observed, and it was confirmed that the NiFe layer which constituted the upper crystalline magnetic layer 5 had a crystal structure.

On the other hand, in Comparative Example B in which the upper crystalline magnetic layer 5 was not formed, a diffraction peak did not appear and it was confirmed that the CoNbZr upper soft magnetic underlying layer 6 was amorphous.

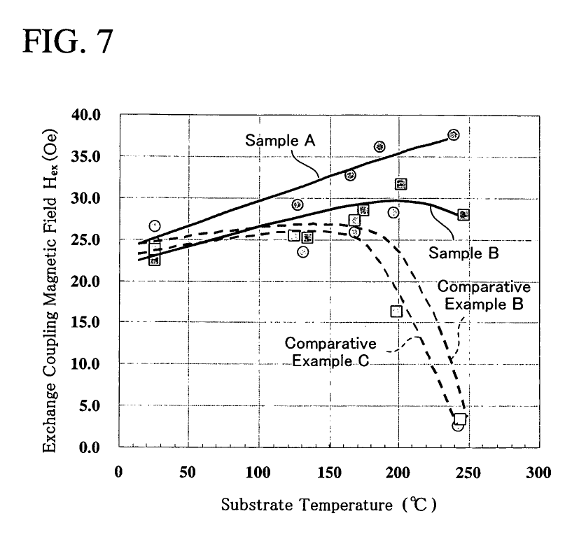

FIG. 7 is a graph obtained after investigating how the exchange coupling magnetic field Hₑₓ in the soft magnetic underlying layers 2 and 6 varied with the substrate temperature in Samples A and B, and Comparative Examples B and C, respectively.

As shown in FIG. 7, while in Comparative Examples B and C the exchange coupling magnetic field Hₑₓ began to decrease at the substrate temperature of approximately 170° C. or more, in Samples A and B a distinctive reduction in the exchange coupling magnetic field Hₑₓ was not observed even if the substrate temperature rose.

As previously described, in order to form the protective layer 10 with a densified and smooth film quality, the deposition temperature of the protective layer 10 needs to be on the order of 200° C. Therefore, in Comparative Examples B and C, the improvement in the film quality of the protective layer 10 and the suppression of the magnetic leakage flux from the soft magnetic underlying layers 2 and 6 could not be reconciled. On the other hand, in Samples A and B, the exchange coupling magnetic field Hₑₓ did not decrease at the substrate temperature of 200° C., and it was possible to form the protective layer 10 with an excellent film quality, while coupling the respective soft magnetic underlying layers 2 and 6 anti-ferromagnetically.

From the results of FIG. 7, it was confirmed that by forming the crystalline magnetic layers 3 and 5 like in this embodiment, the soft magnetic underlying layers 2 and 6 anti-ferromagnetically coupled to each other more strongly than in the case where the crystalline magnetic layers 3 and 5 were not formed.

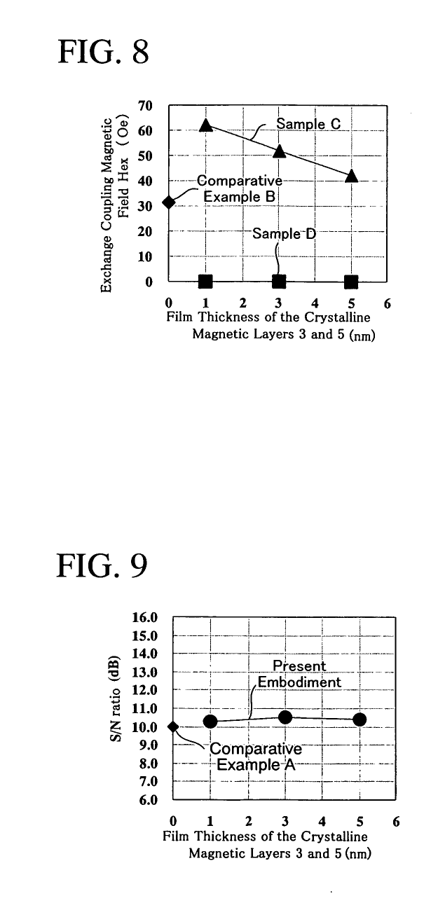

FIG. 8 is a graph obtained after investigating a relationship between the film thickness of the crystalline magnetic layers 3 and 5, and the exchange coupling magnetic field Hₑₓ in the soft magnetic underlying layers 2 and 6.

As shown in FIG. 8, it is appreciated that in Sample C, in which a Co layer is formed as the crystalline magnetic layers 3 and 5 to a thickness of 1 nm or more that is considered as a continuous layer, the exchange coupling magnetic field Hₑₓ with a sufficient magnitude generated and the soft magnetic underlying layers 2 and 6 coupled to each other anti-ferromagnetically. Moreover, in this sample C, the magnitude of the exchange coupling magnetic field Hₑₓ varied also depending on the film thickness of the crystalline magnetic layers 3 and 5.

On the other hand, in Sample D, in which an Fe layer is formed as the crystalline magnetic layers 3 and 5, the exchange coupling magnetic field Hₑₓ was very small. This is because, as disclosed in Non-patent Document 3, the magnitude of the exchange coupling magnetic field Hₑₓ in the soft magnetic underlying layers 2 and 6 varies depending on a combination of the materials of the crystalline magnetic layers 3 and 5 and the non-magnetic layer 4.

From the result of FIG. 8, it is appreciated that in order to obtain a large exchange coupling magnetic field Hₑₓ independent of external environmental changes, it is important to adequately combine the materials and the film thicknesses of the crystalline magnetic layers 3 and 5 and the non-magnetic layer 4.

In addition, according to the experiments conducted by the present inventors, it was confirmed that in the case where the NiFe layer was formed as the lower soft magnetic underlying layer 2 and lower crystalline magnetic layer 3, the exchange coupling magnetic field Hₑₓ of these layers did not become zero even if the thickness of each of the underlying layers 2 and 3 was set to 0.5 nm, and these layers anti-ferromagnetically coupled to each other. Therefore, it is preferable that the lower limit of the thickness of the lower soft magnetic underlying layer 2 and the lower crystalline magnetic layer 3 be set to 0.5 nm.

FIG. 9 is a graph obtained after investigating a relationship between the film thickness of the crystalline magnetic layers 3 and 5 and the S/N ratio in this embodiment which has the sectional structure of FIG. 1C.

As shown in FIG. 9, it is appreciated that the S/N ratio of this embodiment was substantially equal to that of Comparative Example A, so that even if the crystalline magnetic layers 3 and 5 were formed above or below the non-magnetic layer 4, the S/N ratio was not much affected.

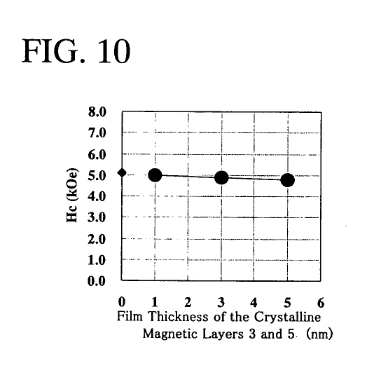

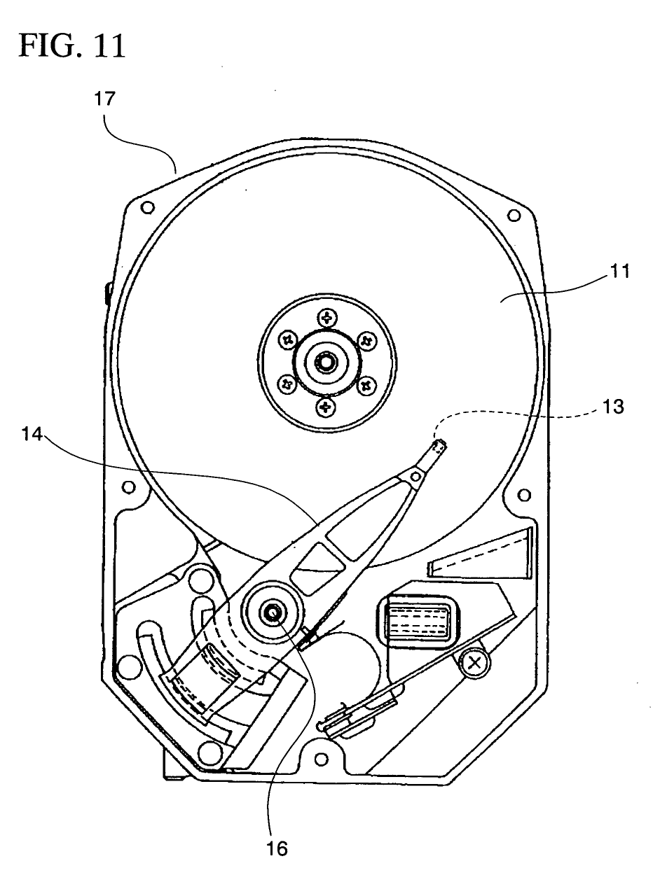

FIG. 10 is a graph obtained after investigating a relationship between the film thickness of the crystalline magnetic layers 3 and 5, and a coercivity H_{c} of the recording layer 9 in this embodiment which has the cross sectional structure of FIG. 1C.

As shown in FIG. 10, the coercivity H_{c} slightly decreased as the thickness of the crystalline magnetic layers 3 and 5 increased. If the thickness of the crystalline magnetic layers 3 and 5 becomes 10 nm, though the thickness is out of the range of this graph, the amount of reduction in the coercivity H_{c} is on the order of 500 Oe as compared with a case of 1 nm. Because reduction in the coercivity H_{c} leads to degradation of record reproducing characteristics, such as a side erase, the thickness of the crystalline magnetic layers 3 and 5 is preferably set to 10 nm or less, and is more preferably set to 5 nm or less.

### (2) Second Embodiment

In this embodiment, a magnetic recording apparatus comprising the above-described magnetic recording medium 11 of the first embodiment is described.

FIG. 11 is a plane view of the magnetic recording apparatus. This magnetic recording apparatus is a hard disk drive unit to be installed in a personal computer, or in a video-recording apparatus of a television.

In this magnetic recording apparatus, by means of a spindle motor or the like, the magnetic recording medium 11 is rotatably mounted in a housing 17 as a hard disk. Furthermore, a carriage arm 14 is provided in the housing 17, which is rotatable about an axis 16 by means of an actuator or the like. A magnetic head 13 is provided at the tip of the carriage arm 14. The magnetic head 13 scans the magnetic recording medium 11 from the above, thereby carrying out writing and reading of magnetic information to and from the magnetic recording medium 11.

It should be noted that the type of the magnetic head 13 is not limited. The magnetic head 13 may be composed of a magneto-resistive element, such as a GMR (Giant Magneto-Resistive) element and a TuMR (Tunneling Magneto-Resistive) element.

According to the magnetic recording apparatus configured this way, because the crystalline magnetic layers 3 and 5 are formed above and below the non-magnetic layer 4, the diffusion of the constituent material of the non-magnetic layer 4 into the lower soft magnetic underlying layer 2 or into the upper soft magnetic underlying layer 6 due to an aged deterioration or the like is suppressed and the reliability in information retention is guaranteed over a long period of time.

Note that the magnetic recording apparatus is not limited to the above-described hard disk unit but may be an apparatus for recording magnetic information into a magnetic recording medium in the shape of a flexible tape.

Although the embodiments of the present invention have been described in detail, the present invention is not limited to each embodiment. For example, although both crystalline magnetic layers 3 and 5 are formed above and below the non-magnetic layer 4 in the first embodiment as shown in FIG. 1C, only one of these films may be formed. Even in this case, the diffusion of the constituent elements of the non-magnetic layer 4 is suppressed by the remaining crystalline magnetic layer.

As described above, according to the present invention, because a crystalline magnetic layer is formed between a lower soft magnetic underlying layer and a non-magnetic layer or between the non-magnetic layer and an upper soft magnetic underlying layer, the diffusion of the constituent element of the non-magnetic layer into the lower soft magnetic underlying layer or into the upper soft magnetic underlying layer is prevented. Therefore, it is possible to anti-ferromagnetically couple the respective soft magnetic underlying layers excellently, and the spike noise caused by a magnetic leakage flux from each soft magnetic underlying layer can be reduced.

What is claimed is:

1. A magnetic recording medium comprising:
a base member;
a lower soft magnetic underlying layer formed on the base member;
a non-magnetic layer formed on the lower soft magnetic underlying layer;
an upper soft magnetic underlying layer formed on the non-magnetic layer; and
a recording layer formed on the upper soft magnetic underlying layer and having a perpendicular magnetic anisotropy,
wherein a crystalline magnetic layer is formed between the lower soft magnetic underlying layer and the non-magnetic layer or between the non-magnetic layer and the upper soft magnetic underlying layer.

2. The magnetic recording medium according to claim 1, wherein at least any one of the lower soft magnetic underlying layer and the upper soft magnetic underlying layer is composed of any one of an amorphous material and a microcrystalline material.

3. The magnetic recording medium according to claim 2, wherein at least any one of the lower soft magnetic underlying layer and the upper soft magnetic underlying layer is composed of an alloy in which at least any one of Zr, Ta, C, Nb, Si and B is added to any one of a Co group, an Fe group and an Ni group.

4. The magnetic recording medium according to claim 1, wherein a magnetization of the lower soft magnetic underlying layer and a magnetization of the upper soft magnetic underlying layer in a portion adjacent to the magnetization of the lower soft magnetic underlying layer mutually direct in opposite directions.

5. The magnetic recording medium according to claim 1, wherein a protective layer is formed on the recording layer.

6. The magnetic recording medium according to claim 5, wherein the protective layer is composed of DLC.

7. The magnetic recording medium according to claim 1, wherein the crystalline magnetic layer is composed only of any one of Ni, Fe, and Co, or composed of an alloy containing any one of these elements.

8. The magnetic recording medium according to claim 1, wherein the thickness of the crystalline magnetic layer lies in a range of 0.5 nm to 10 nm.

9. The magnetic recording medium according to claim 1, wherein the non-magnetic layer is composed only of any one of Ru, Rh, Ir, Cu, Cr, Re, Mo, Nb, W, Ta and C, or composed of an alloy containing at least any one of these elements, or composed of MgO.

10. A method of manufacturing a magnetic recording medium comprising the steps of:
forming a lower soft magnetic underlying layer on a base member;
forming a non-magnetic layer on the lower soft magnetic underlying layer;
forming an upper soft magnetic underlying layer on the non-magnetic layer;
forming a recording layer on the upper soft magnetic underlying layer, the recording layer having a perpendicular magnetic anisotropy; and
forming a protective layer on the recording layer while heating the base member,
wherein the method includes a step of forming a crystalline magnetic layer on the lower soft magnetic underlying layer before the step of forming the non-magnetic layer, or the step of forming the crystalline magnetic layer on the non-magnetic layer before the step of forming the upper soft magnetic underlying layer.

11. The method of manufacturing a magnetic recording medium according to claim 10, wherein a soft magnetic layer composed of any one of an amorphous material and a microcrystalline material is formed as at least any one of the lower soft magnetic underlying layer and the upper soft magnetic underlying layer.

12. The method of manufacturing a magnetic recording medium according to claim 10, wherein a magnetic layer, which is composed only of any one of Ni, Fe and Co, or composed of an alloy containing any one of these elements, is formed as the crystalline magnetic layer.

13. The method of manufacturing a magnetic recording medium according to claim 10, wherein a DLC layer is formed as the protective layer.

14. A magnetic recording apparatus comprising:
a magnetic recording medium comprising:
a base member;
a lower soft magnetic underlying layer formed on the base member;
a non-magnetic layer formed on the lower soft magnetic underlying layer;
an upper soft magnetic underlying layer formed on the non-magnetic layer; and
a recording layer formed on the upper soft magnetic underlying layer and having a perpendicular magnetic anisotropy; and
a magnetic head provided so as to face the magnetic recording medium,
wherein a crystalline magnetic layer is formed between the lower soft magnetic underlying layer and the non-magnetic layer or between the non-magnetic layer and the upper soft magnetic underlying layer.

15. The magnetic recording apparatus according to claim 14, wherein at least any one of the lower soft magnetic underlying layer and the upper soft magnetic underlying layer is composed of any one of an amorphous material and a microcrystalline material.

16. The magnetic recording apparatus according to claim 14, wherein the crystalline magnetic layer is composed only of any one of Ni, Fe and Co, or composed of an alloy containing any one of these elements.
